(19) United States
(12) Patent Application Publication
(10) Pub. No.: US 2018/0160759 A1
(43) Pub. Date: Jun. 14, 2018

(54) Bicycle Helmet

(71) Applicant: CYCLEVISION PTY LTD, Trinity Beach (AU)

(72) Inventors: Robert Asker, Trinity Beach (AU); Edward Joseph Khoury, Bateman (AU)

(21) Appl. No.: 15/573,063

(22) PCT Filed: May 16, 2016
(86) PCT No.: PCT/AU2016/050368

§ 371 Date: Nov. 9, 2017

(30) Foreign Application Priority Data
May 18, 2015 (AU) 2015901780
Mar. 9, 2016 (AU) 2016900877

(51) Int. Cl. A42B 3/04; H04N 5/225; A42B 3/06; H04N 5/77

(52) U.S. Cl. CPC A42B 3/042; H04N 5/772; A42B 3/066; H04N 5/2257

(57) ABSTRACT

A bicycle helmet (10) comprising a liner (12) and a shell (14) provided around the liner (12). One or more cameras (20) are each secured within a mounting body (26) provided on a support frame (19) integrally formed within the liner (12). Each of the support frames (19) includes a spine (5) provided on a central axis extending from a front of the helmet (10) to a rear of the helmet (10) and a plurality of arms (46) are provided extending transversely outwardly from the spine (50) within the liner (12) of the helmet (10) to distribute the force of any impact on the mounting body (26) into the liner (12).

### FIELD OF THE INVENTION

The present invention relates to a bicycle helmet.

### BACKGROUND TO THE INVENTION

Bicycle riders are generally required to wear head protection while riding. It is also becoming more common for cyclists to wish to have a video recording device when they ride, in order to capture video of any incidents that may occur while cycling. Various devices have been proposed that utilise a video camera mounting arrangement. The video camera may be mounted, for example, to the bicycle. Mounting arrangements have also been proposed for the helmets worn by cyclists. However, ensuring the camera is secured in the correct orientation and stable relative to the helmet can be difficult.

Helmets have been developed in which a camera is permanently fitted within the structure of the helmet. Ensuring however that the camera is securely mounted and that the structural integrity of the helmet is not adversely affected can be problematic. The present invention relates to a bicycle helmet incorporating a video camera system in a way which effectively records video footage and does not detract from the strength of the helmet.

### SUMMARY OF THE INVENTION

According to one aspect of the present invention there is provided a bicycle helmet comprising:

a liner;
a shell provided around the liner; and
one or more cameras each secured within a mounting body provided on a support frame integrally formed within the liner;
wherein each of the support frames including a spine provided on a central axis extending from a front of the helmet to a rear of the helmet and a plurality of arms extending transversely outwardly from the spine within the liner of the helmet to distribute the force of any impact on the mounting body into the liner.

Preferably the arms extend outwardly from opposed sides of the spine.

Preferably the arms are provided in pairs extending transversely outwardly from the spine.

Preferably the arms each comprise planar elongate members extending from opposed sides of the spine.

Preferably the arms are curved to follow the curvature of the helmet such that the arms are embedded within the liner of the helmet.

Preferably each of the arms is provided with one or more holes such that the material of the liner is formed through the holes to anchor the arms relative to the liner.

In a preferred embodiment, there is provided a forward support frame adjacent a front of the helmet including a forward camera in a forward housing and a rear support frame adjacent a rear of the helmet including a rear camera in a rear housing.

Preferably the forward and rear housings define forward and rear chambers into which are the received forward and rear cameras respectively, the forward and rear chambers being closed by first and second covers respectively, each of the first and second covers including a window through which is directed the camera.

In a preferred embodiment, the spine of the forward support frame extends rearwardly from the forward housing.

In one embodiment, a first pair of arms is provided extending outwardly from opposed sides of the forward housing and a second pair of arms is provided extending outwardly from a rear end of the spine.

Preferably a battery housing is provided for receiving the battery, the battery housing comprising a elongate housing extending forwardly from an upper end of the rear housing.

Preferably a longitudinal axis of the battery housing is oriented at an angle to a longitudinal axis of the rear housing such that the rear housing extends centrally up the rear side of the bicycle helmet and the battery housing extends from an upper end of the rear housing across an upper side of the bicycle helmet.

In a preferred embodiment, the rear housing and the battery housing form the spine of the rear support frame.

In a preferred embodiment, the spine of the rear support frame includes a first pair of arms extending outwardly from adjacent a lower end of the rear housing, a second pair of arms extending outward from adjacent a forward end of the battery housing and a third pair of arms adjacent the junction of the rear housing and the battery housing.

Preferably the forward and rear housings are connected via a cable for transmission of image data.

Preferably the cable passes through the holes of the arms to secure it relative to the support frames.

In a further embodiment, first and second cameras are mounted within the helmet, the first and second cameras being directed at different angles relative to a horizontal plane, and an angle is sensor provided to detect angular changes in the position of the helmet relative to the horizontal plane, wherein operation of the first or second cameras is dependent on the position of the helmet determined by the angle sensor.

Preferably the first and second cameras are oriented in different directions relative to a longitudinal axis extending from the front to the rear of the bicycle helmet and the angle sensor detects tilting of the longitudinal axis relative to a horizontal plane.

Preferably when the longitudinal axis rotates beyond a predetermined position relative to the horizontal in a first direction, the first camera is activated to record images and when the longitudinal axis rotates beyond a predetermined position relative to the horizontal in a second direction, the second camera is activated.

Preferably forward first and second cameras are mounted in a front region of the bicycle helmet adjacent a lower rim and rear first and second cameras are mounted in a rear region of the bicycle helmet adjacent the lower rim.

Preferably the forward first camera is directed generally horizontally when the bicycle helmet is positioned with the lower rim lowermost and horizontal, the forward second camera is directed at an angle upwardly relative to the horizontal plane, the rear second camera is directed at an angle slightly downwardly relative to the horizontal plane and the rear first camera is directed generally horizontally.

Preferably the forward and rear first cameras are oriented in generally the same horizontal plane, with the forward second camera directed upwardly and the rear second camera directed downwardly.

Preferably the angle sensor device comprises an accelerometer.

### BRIEF DESCRIPTION OF THE DRAWINGS

The invention will now be described, by way of example, with reference to the following drawings, in which:

FIG. 1 is an upper perspective of a bicycle helmet in accordance with the present invention;

FIG. 2a is a rear view of the bicycle helmet of FIG. 1;

FIG. 2b is a front view of the bicycle helmet of FIG. 1;

FIG. 3 is a view of the bicycle helmet of FIG. 1 with the forward and rear housings and straps disassembled;

FIG. 4a is a front view of the bicycle helmet of FIG. 1;

FIG. 4b is a cross sectional view of the bicycle helmet of FIG. 4a through the line A-A;

FIG. 5 is an upper perspective view of the camera assembly of the bicycle camera of FIG. 1; and

FIG. 6 is a top view of the camera assembly of the bicycle camera of FIG. 1;

FIG. 7 is an exploded view of components of the forward housing of the bicycle helmet of FIG. 1;

FIG. 8 is an exploded view of components of the rear housing of the bicycle helmet of FIG. 1;

FIG. 9a is a front upper perspective view of a second embodiment of bicycle helmet in accordance with the present invention;

FIG. 9b is a rear upper perspective view of the bicycle helmet of FIG. 9a;

FIG. 10a is an upper perspective view of the camera assembly of he bicycle helmet of FIG. 9;

FIG. 10b is a lower perspective view of the camera assembly of the bicycle helmet of FIG. 9;

FIG. 11 is an exploded view of the camera assembly of the bicycle helmet of FIG. 9; and

FIG. 12 is a side cross sectional view of the bicycle helmet of FIG. 9.

### DETAILED DESCRIPTION OF PREFERRED EMBODIMENTS

Referring to the Figures, there is shown a bicycle helmet 10 comprising a liner 12 and a shell 14. The construction of the liner 12 and shell 14 is expected to be similar to a standard bicycle helmet 10. The liner 12 forms the main body of the bicycle helmet 10 and is formed from a material such as a foam of polystyrene. The shell 14 encloses the outer surface of the liner 12 and is formed of a suitable plastic material. The liner 12 and shell 14 include a plurality of openings 16 provided for airflow.

The bicycle helmet 10 is provided with a camera assembly 18 including one or more cameras for capturing video images. The camera assembly 18 is to be mounted at least partially within the liner 12 such that the camera assembly 18 is permanently secured within the bicycle helmet 10.

In the embodiment shown, the camera assembly 18 includes cameras 20 provided to capture images both in front and behind the person wearing the bicycle helmet 10. The bicycle helmet 10 is therefore provided with a forward camera 20a and a rear camera 20b. The forward camera 20a is mounted in a front region of the bicycle helmet 10 adjacent a lower rim 24 of the bicycle helmet 10. The rear camera 20b is mounted in a rear region of the bicycle helmet 10 adjacent the lower rim 24 of the bicycle helmet 10.

Each of the forward and rear cameras 20a and 20b is mounted to a mounting body 26. A forward mounting body 26a is provided for mounting of the forward camera 20a and a rear mounting body 26b is provided for mounting of the rear camera 20b.

The forward mounting body 26a comprises a forward housing 32 defining a forward chamber 34 into which the forward camera 20a is received. A first cover 38 is securable to the forward housing 32 to close off the forward chamber 34. The first cover 38 includes a window 36 therein through which the forward camera 20a is directed. The forward camera 20a is secured to a circuit board 31 mounted within the forward housing 32 such that the forward camera 20a is directly outwardly through the window 36.

The rear mounting body 26b comprises a rear housing 40 defining a rear chamber 41. The rear camera 20b is received within the rear chamber 41 of the rear housing 40 and a second cover 42 is received across an opening in the rear housing 40. The rear camera 20b is provided on a circuit board 31 mounted within the rear housing 40 such that the rear camera 20b is directed outwardly through a windows 36 provided in the second cover 42.

A power source, in the form of a rechargeable battery 30, is provided along with control circuitry on one of the circuit boards 31, or a separate circuit board 31 provided within either the forward or rear housing 32 or 40. In the embodiment shown, the control circuitry is housed in the rear housing 40.

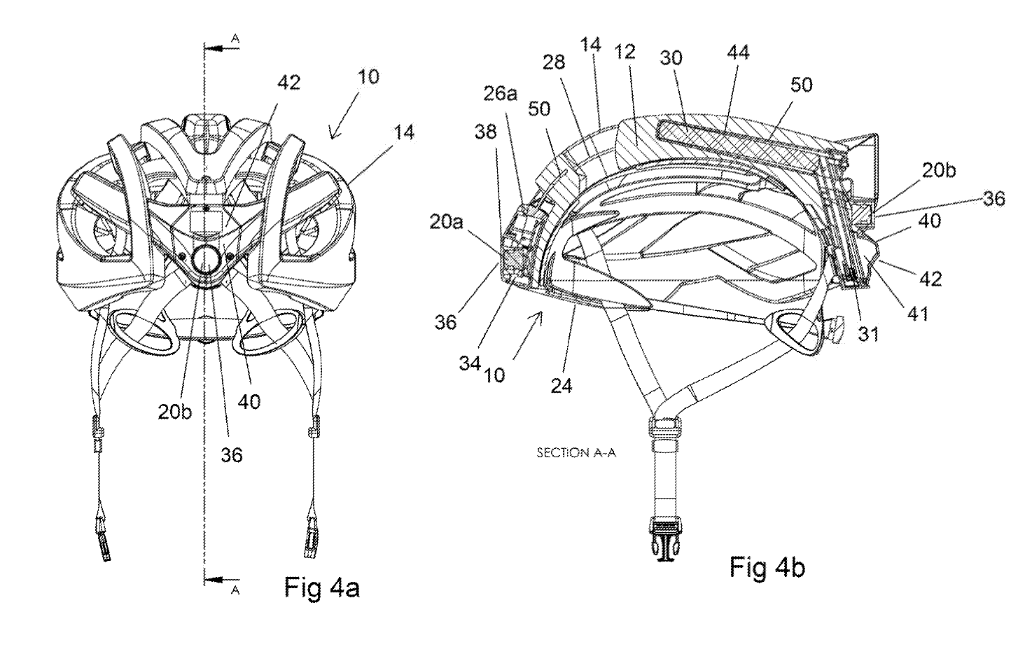

A battery housing 44 is provided for receiving the battery 30. The battery housing 44 is elongate in shape and extends from an upper end of the rear housing 40. A longitudinal axis of the battery housing 44 is oriented at an angle to the longitudinal axis of the rear housing 40 such that the rear housing 40 extends generally centrally up the rear side of the bicycle helmet 10 and the battery housing 44 extends from an upper end of the rear housing 40 across an upper side of the bicycle helmet 10, as can be seen in FIG. 4b.

The forward and rear housings 32 and 40 are connected via a cable 28 for transmission of image data. The camera assembly 18 formed from the rear housing 40, the battery housing 44, the forward housing 32 and the cable 28 is to be enclosed within the liner 12 of the bicycle helmet 10. It is expected that the camera assembly 18 will be placed in position during formation of the foam material of the liner 12 such that the camera assembly 18 is encapsulated by the foam material.

The bicycle helmet 10 is provided also with a data storage device for storing video captured by the cameras 20. The data storage device may comprise a micro SD card mounted within the rear housing 40. The bicycle helmet 10 may also include a wireless transmission device such that recorded images may be transmitted wirelessly to another device, such as a smart phone. A port, such as a USB port, may be provided for accessing data on the storage device and also for charging the battery 30.

Seals 48 are provided around the first and second covers 38 and 42 to prevent ingress of moisture into the forward and rear housings 32 and 40.

The camera assembly 18 includes also support frames 19 extending from the forward and rear mounting bodies 26a and 26b. There is therefore provided a forward support frame 19a and a rear support frame 19b.

Each of the support frames 9 comprises a central spine 50 and a plurality of arms 46 extending outwardly from the spine 50. The spine 50 of each of the support frames 19 comprises an elongate member oriented to extend along a central axis of the bicycle helmet 10 extending from adjacent the front of the helmet 10 to adjacent the rear of the helmet 10. The forward housing 32 is provided on the spine 50 of the forward support frame 19a and the rear housing 40 is provided on the spine 50 of the rear support frame 19b.

In the embodiment shown, the spine 50 of the forward support frame 19a extends rearwardly away from the forward housing 32. The spine 50 of the rear support frame 19b is formed by the connected rear housing 40 and battery housing 44.

The arms 46 are provided in pairs extending transversely outwardly from the spines 50 of the forward and rear support frames 19a and 19b. The arms 46 each comprise planar elongate members extending from opposed sides of the spine 50. The arms 46 are curved to follow the curvature of the helmet 10 such that the arms 46 are embedded within the liner 10 of the helmet 10.

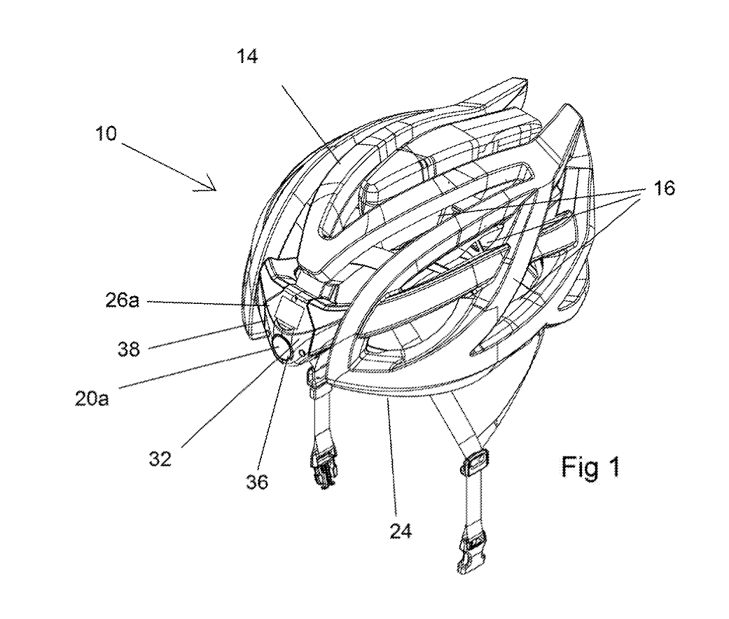

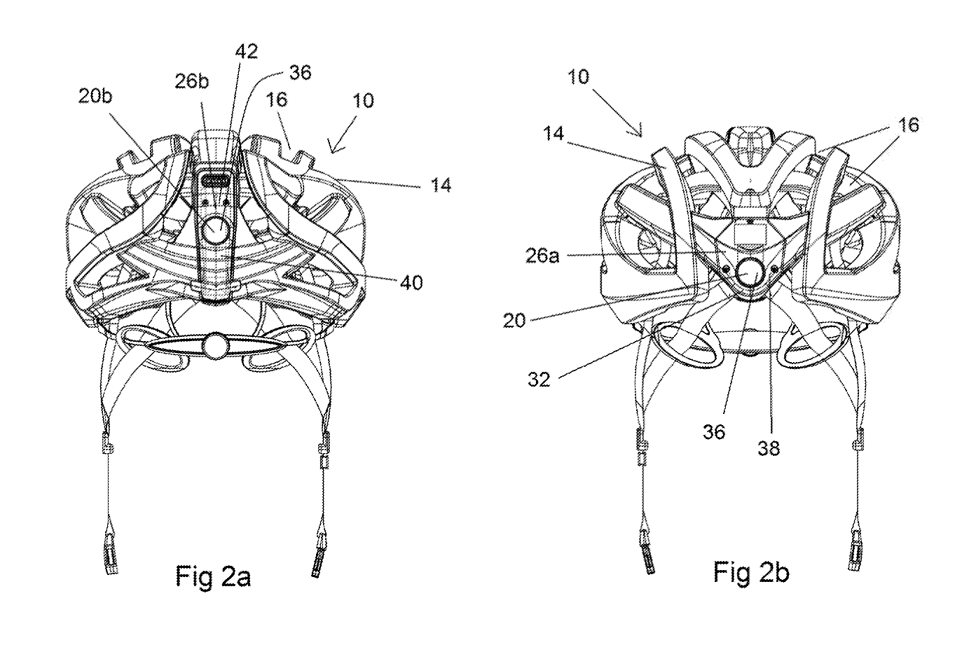

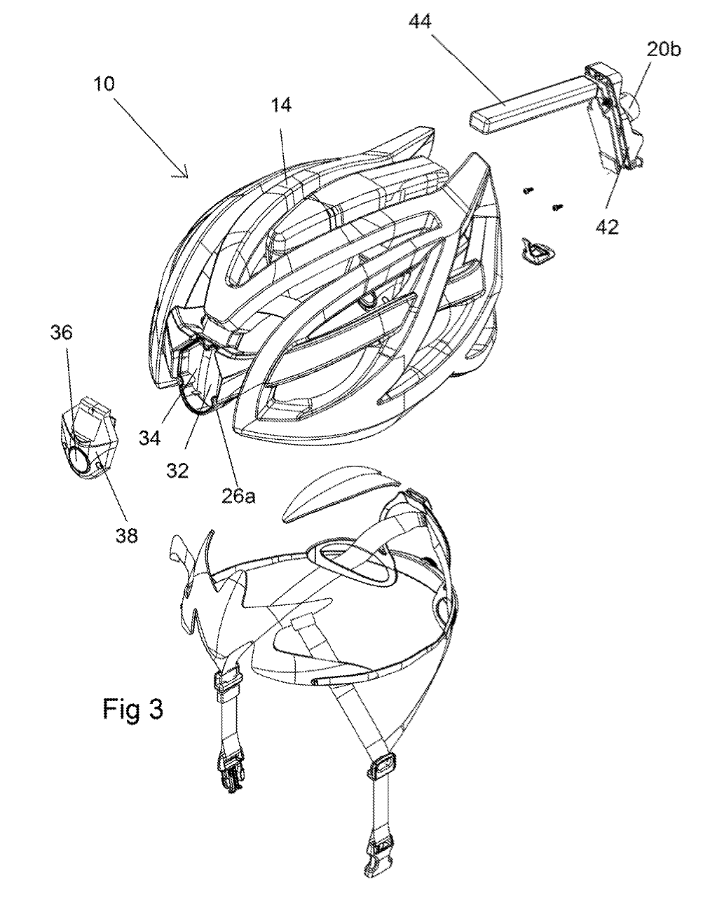

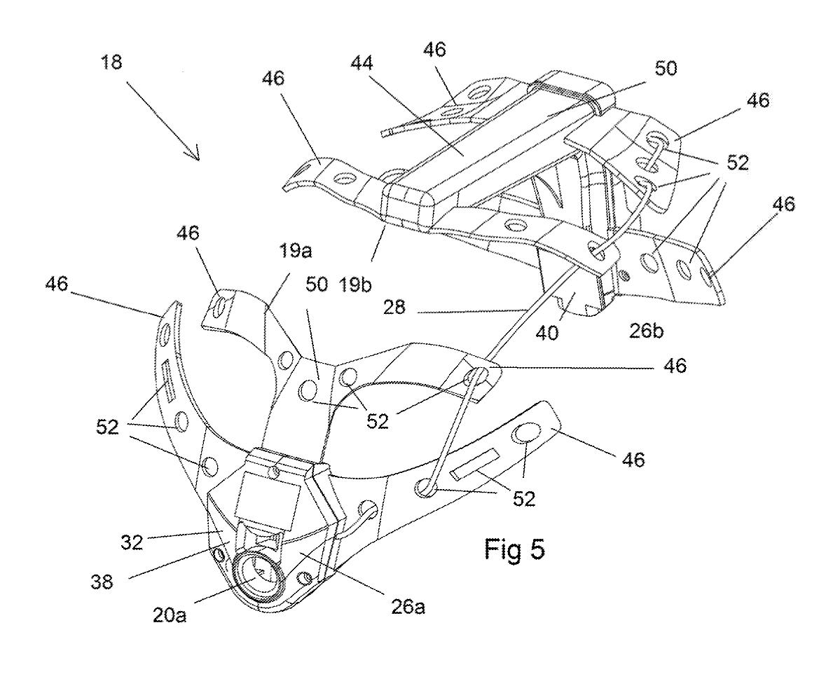

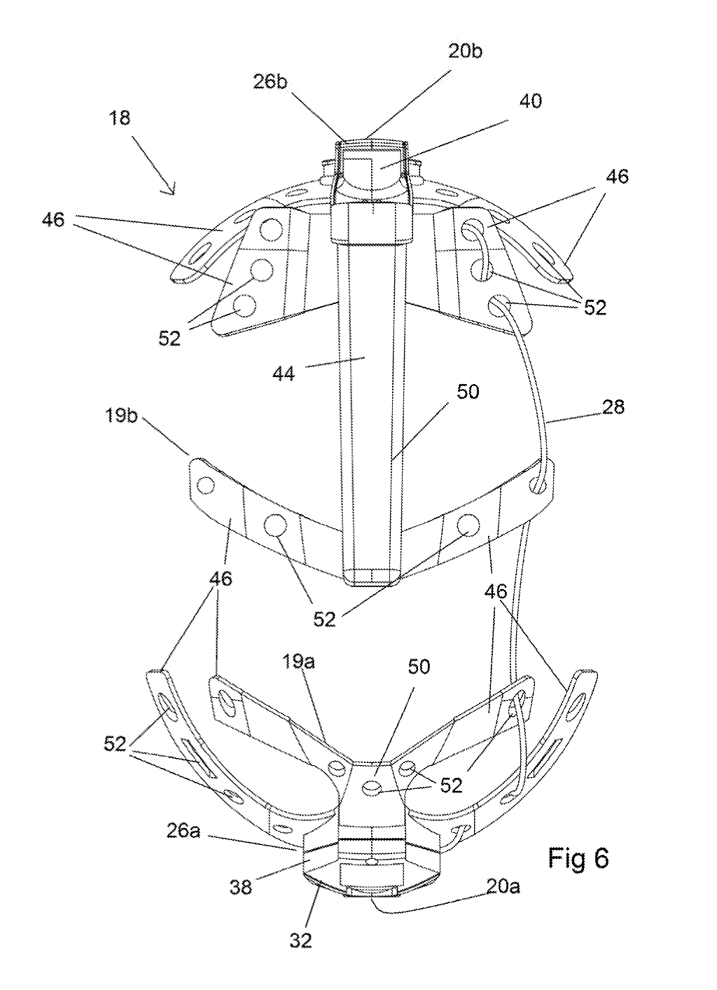

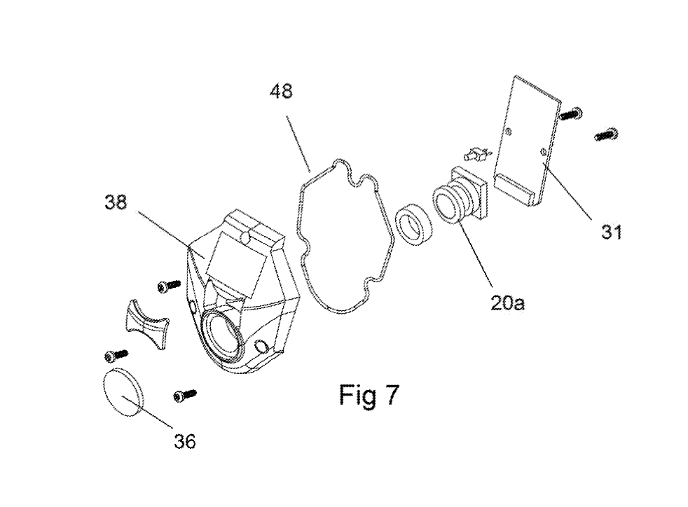

In the embodiment shown in FIGS. 1 to 7, a first pair of arms 46 is provided extending outwardly from opposed sides of the forward housing 32. A second pair of arms 46 is provided extending outwardly from a rear end of the spine 50 of the forward support frame 19a.

The spine 50 of the rear support frame 19b includes a first pair of arms 40 extending outwardly from adjacent a lower end of the rear housing 40. A second pair of arms 46 is provided extending outwardly from adjacent a forward end of the battery housing 44 and a third pair of arms 46 is provided adjacent the junction of the rear housing 40 and the battery housing 44.

Each of the arms 46 is provided with one or more holes 52 therein. The holes 52 are provided such that the material of the liner 12 is formed through the holes 52 to anchor the arms 46 relative to the liner 12. The arrangement of the support frames 19 therefore act to distribute any force which may be caused by an impact to the camera assembly 18. The distribution of force from impact to the housings 32 and 40 will assist in allowing the helmet 10 to meet the required safety standards for a bicycle helmet 10. The cable 28 passes through the holes 52 of the arms 46 to secure it relative to the camera assembly 18.

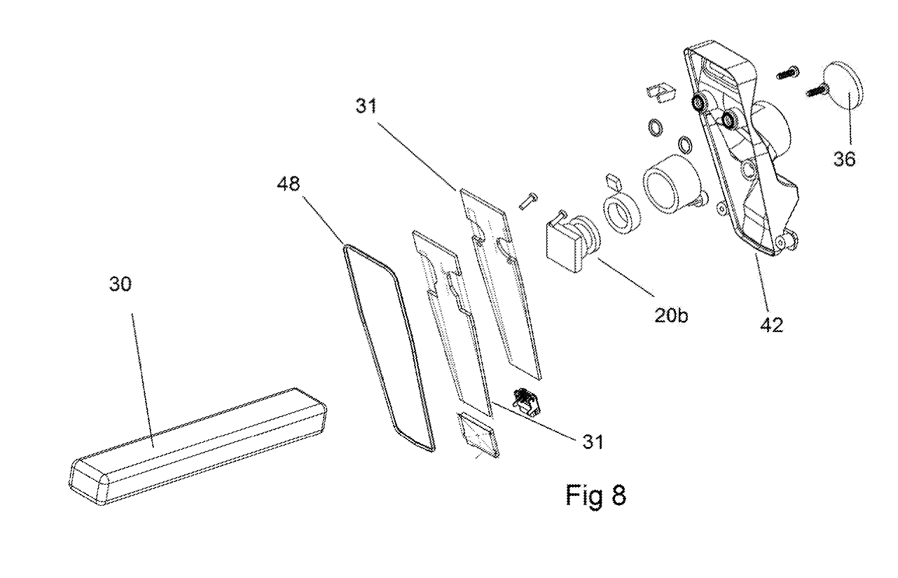

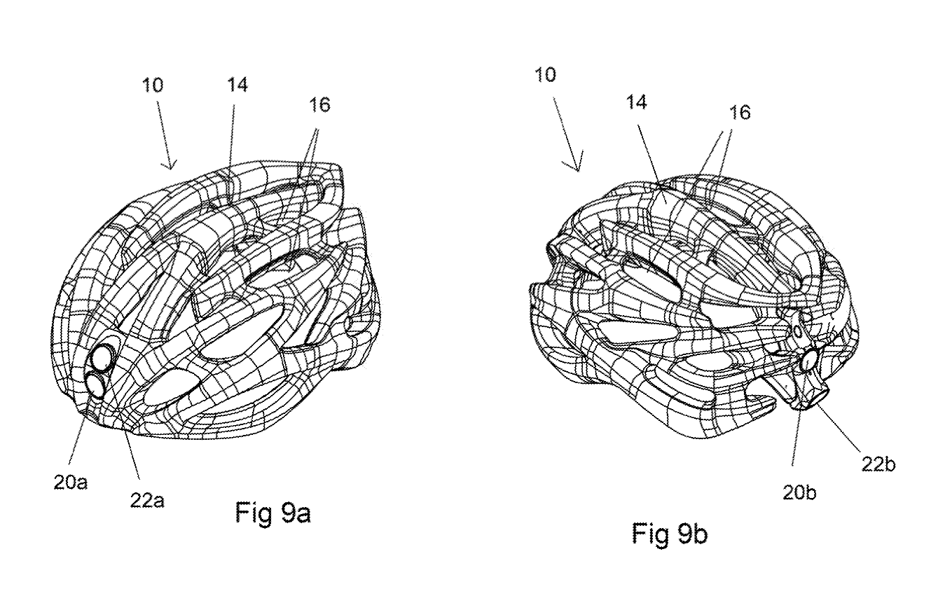

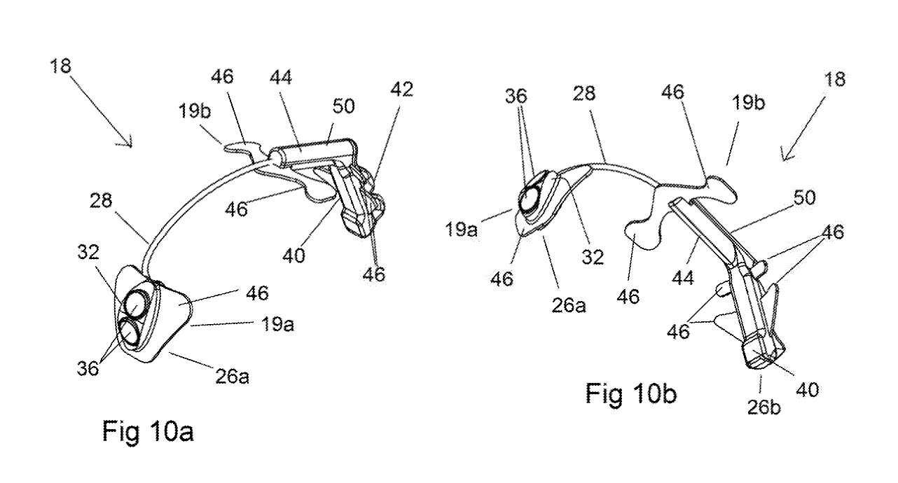

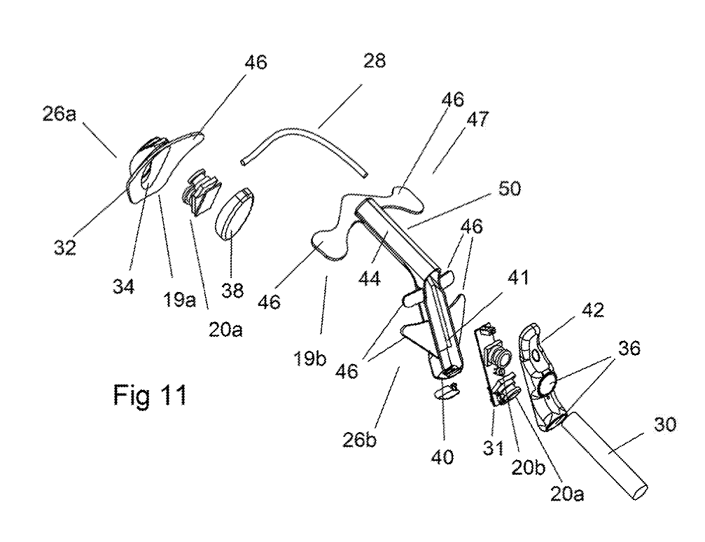

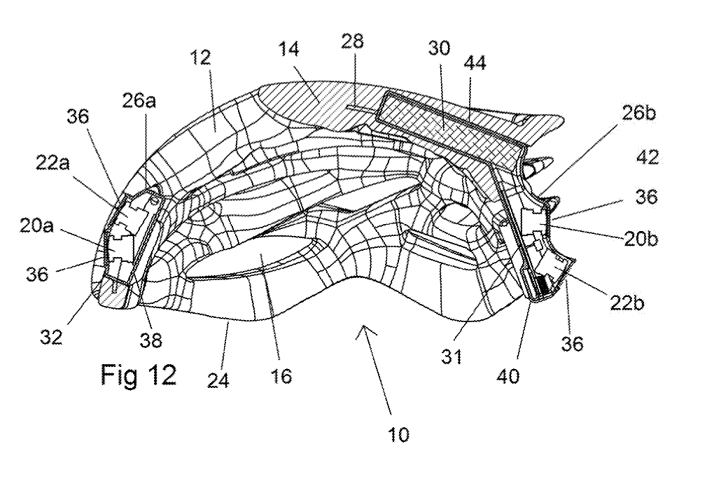

FIGS. 9 to 12 show a second embodiment of a bicycle helmet 10 in accordance with the present invention. The bicycle helmet 10 of FIGS. 9 to 12 is similar to the embodiment of FIGS. 1 to 8 and like reference numerals are used to denote like parts.

In the embodiment of FIGS. 9 to 12, the camera assembly 18 includes first and second cameras 20 and 22 where the first and second cameras 20 and 22 are mounted to capture images both forwardly and rearwardly of the bicycle helmet 10. The bicycle helmet 10 is therefore provided with forward first and second cameras 20a and 22a and rear first and second cameras 20b and 22b. The forward first and second cameras 20a and 22a are mounted in the forward housing 32 and the rear first and second cameras 20b and 22b are mounted in the rear housing 40.

The first and second cameras 20 and 22 are mounted to be directed at different angles relative to a horizontal plane. In the embodiment shown, the forward first camera 20a is directed generally horizontally when the bicycle helmet 10 is positioned with the lower rim 24 lowermost and horizontal. The forward second camera 22a is directed at an angle upwardly relative to the horizontal plane. The rear second camera 22b is directed at an angle slightly downwardly relative to the horizontal plane and the rear first camera 20b is directed generally horizontally. That is, in the embodiment shown, the forward and rear first cameras 20a and 20b are oriented in generally the same horizontal plane, with the forward second camera 22a being directed upwardly and the rear second camera 22b directed downwardly.

The bicycle helmet 10 of FIGS. 9 to 12 is provided with an angle sensor. The angle sensor in the embodiment shown comprises a suitable component, such as an accelerometer, located on one of the circuit boards 31. It will be appreciated however that the angle sensor may comprise any suitable component secured relative to the bicycle helmet 10.

The angle sensor is provided to sense changes in the angular position of the bicycle helmet 10. In particular, the angle sensor is provided to detect tilting of a longitudinal axis extending from the rear of the bicycle helmet 10 to the front of the bicycle helmet 10. That is, the angle sensor detects tilting of the bicycle helmet 10 which would result in the front and rear of the bicycle helmet 10 moving upwardly or downwardly relative to each other.

The operation of the first and second cameras 20 and 22 is based on the output of the angle sensor. In particular, when the longitudinal axis rotates beyond a predetermined position relative to the horizontal in a first direction, the forward and rear first cameras 20a and 20b are activated to record images. When the longitudinal axis rotates beyond a predetermined position relative to the horizontal in a second direction, the forward and rear second cameras 22a and 22b are activated.

In this way, the bicycle helmet 10 can record images using the most appropriately positioned camera, regardless of changes in head position of the rider. This is particularly useful as riders of bicycles will often change position from a more upright position to a position in which they are leaning forward. For example, when a rider utilises drop bars on a typical road bike, they will be leaning forward, resulting in the helmet tilting forward. In other positions however they may be more vertical. The bicycle helmet 10 may therefore use the most appropriate cameras, to record images both forwardly and rearwardly of the rider.

The forward housing 32 in this embodiment includes only a single pair of arms 46 extending outwardly from the sides thereof. Also, the forward chamber 34 of the forward housing is closed off by a first cover 38 secured to the inner side of the forward housing 32

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A bicycle helmet comprising:
a liner;
a shell provided around the liner; and
one or more cameras each secured within a mounting body provided on a support frame integrally formed within the liner;
wherein each of the support frames including a spine extending along at least a portion of a central axis extending from a front of the helmet to a rear of the helmet and a plurality of arms extending transversely outwardly from the spine within the liner of the helmet to distribute the force of any impact on the mounting body into the liner.

25. A bicycle helmet in accordance with claim 24, wherein the arms extend outwardly from opposed sides of the spine.

26. A bicycle helmet in accordance with claim 25, wherein the arms are provided in pairs extending transversely outwardly from the spine.

27. A bicycle helmet in accordance with claim 26, wherein the arms each comprise planar elongate members extending from opposed sides of the spine.

28. A bicycle helmet in accordance with claim 27, wherein the arms are curved to follow the curvature of the helmet such that the arms are embedded within the liner of the helmet.

29. A bicycle helmet in accordance with claim 28, wherein each of the arms is provided with one or more holes such that the material of the liner is formed through the holes to anchor the arms relative to the liner.

30. A bicycle helmet in accordance with claim 28, wherein there is provided a forward support frame adjacent a front of the helmet including a forward camera in a forward housing and a rear support frame adjacent a rear of the helmet including a rear camera in a rear housing.

31. A bicycle helmet in accordance with claim 30, wherein the forward and rear housings define forward and rear chambers into which are the received forward and rear cameras respectively, the forward and rear chambers being closed by first and second covers respectively, each of the first and second covers including a window through which is directed the camera.

32. A bicycle helmet in accordance with claim 31, wherein the spine of the forward support frame extends rearwardly from the forward housing.

33. A bicycle helmet in accordance with claim 32, wherein a first pair of arms is provided extending outwardly from opposed sides of the forward housing and a second pair of arms is provided extending outwardly from a rear end of the spine.

34. A bicycle helmet in accordance with claim 31, wherein a battery housing is provided for receiving the battery, the battery housing comprising a elongate housing extending forwardly from an upper end of the rear housing.

35. A bicycle helmet in accordance with claim 34, wherein a longitudinal axis of the battery housing is oriented at an angle to a longitudinal axis of the rear housing such that the rear housing extends centrally up the rear side of the bicycle helmet and the battery housing extends from an upper end of the rear housing across an upper side of the bicycle helmet.

36. A bicycle helmet in accordance with claim 35, wherein the rear housing and the battery housing form the spine of the rear support frame.

37. A bicycle helmet in accordance with claim 36, wherein the spine of the rear support frame includes a first pair of arms extending outwardly from adjacent a lower end of the rear housing, a second pair of arms extending outward from adjacent a forward end of the battery housing and a third pair of arms adjacent the junction of the rear housing and the battery housing.

38. A bicycle helmet in accordance with claim 30, wherein the forward and rear housings are connected via a cable for transmission of image data.

39. A bicycle helmet in accordance with claim 38, wherein the cable passes through the holes of the arms to secure it relative to the support frames.

40. A bicycle camera in accordance with claim 24, wherein first and second cameras are mounted within the helmet, the first and second cameras being directed at different angles relative to a horizontal plane, and an angle is sensor provided to detect angular changes in the position of the helmet relative to the horizontal plane, wherein operation of the first or second cameras is dependent on the position of the helmet determined by the angle sensor.

41. A bicycle camera in accordance with claim 40, wherein the first and second cameras are oriented in different directions relative to a longitudinal axis extending from the front to the rear of the bicycle helmet and the angle sensor detects tilting of the longitudinal axis relative to a horizontal plane.

42. A bicycle camera in accordance with claim 41, wherein when the longitudinal axis rotates beyond a predetermined position relative to the horizontal in a first direction, the first camera is activated to record images and when the longitudinal axis rotates beyond a predetermined position relative to the horizontal in a second direction, the second camera is activated.

43. A bicycle camera in accordance with claim 42, wherein forward first and second cameras are mounted in a front region of the bicycle helmet adjacent a lower rim and rear first and second cameras are mounted in a rear region of the bicycle helmet adjacent the lower rim.

44. A bicycle camera in accordance with claim 43, wherein the forward first camera is directed generally horizontally when the bicycle helmet is positioned with the lower rim lowermost and horizontal, the forward second camera is directed at an angle upwardly relative to the horizontal plane, the rear second camera is directed at an angle slightly downwardly relative to the horizontal plane and the rear first camera is directed generally horizontally.

45. A bicycle camera in accordance with claim 44, wherein the forward and rear first cameras are oriented in generally the same horizontal plane, with the forward second camera directed upwardly and the rear second camera directed downwardly.

46. A bicycle camera in accordance with claim 45, wherein the angle sensor device comprises an accelerometer.
